(19) United States
(12) Patent Application Publication
(10) Pub. No.: US 2007/0098866 A1
(43) Pub. Date: May 3, 2007

(54) Low-carbohydrate bread products and method for making same

(76) Inventors: Suzanne M. Waller, Wildwood, MO (US); Richard C. Junge, Carpentersville, IL (US)

Correspondence Address: SOLAE, LLC, PO BOX 88940, ST LOUIS, MO, 63188, US

(21) Appl. No.: 11/261,126

(22) Filed: Oct. 28, 2005

(51) Int. Cl. A21D 10/00

(52) U.S. Cl. 426/549

(57) ABSTRACT

The present invention generally relates to low-carbohydrate dough and bread products and methods for making such products. In particular, the invention relates to low-carbohydrate dough and bread products with high soy protein to additive gluten ratios and physical properties comparable to those of conventional dough and bread products. Soy protein is a low-fat, cholesterol-free, high quality protein that has been associated with a variety of health benefits. The high soy protein and low-carbohydrate bread products of the present invention thus provide not only an appetizing, low-carbohydrate alternative to conventional bread, but a much healthier alternative to conventional bread.

### FIELD OF INVENTION

The present invention generally relates to low-carbohydrate dough and bread products and methods for making such products. In particular, the invention relates to low-carbohydrate dough and bread products with high soy protein to additive gluten ratios and physical properties comparable to those of conventional dough and bread products.

### BACKGROUND

Nearly two-thirds of American adults are overweight, meaning that they have an excess of body weight (from muscle, bone, fat, and/or body water) and some one-third are obese, meaning that they specifically have an abnormally high proportion of body fat. Less than half of Americans maintain a healthy weight. Some 300,000 adult deaths in the United States each year can be attributed to poor dietary habits and a lack of physical activity. U.S. Department of Health and Human Services: The Surgeon General's Call to Action to Prevent and Decrease Overweight and Obesity, 2001. And, the prevalence of obesity and overweight has steadily increased over the years among both genders, all ages, and all ethnic groups. Experts have noted that the number of overweight children has doubled since 1980, while the proportion of overweight adolescents has tripled. In fact, the incidence of type 2 diabetes, a disease associated with obesity that used to occur only in the adult population, has increased dramatically among overweight teens.

Overweight and obesity increase a person's risk of developing a number of diseases including diabetes, heart disease, stroke, hypertension, and some forms of cancer. Obesity has even been linked to complications of pregnancy, menstrual irregularities, and psychological disorders like depression. Thus, as the number of overweight and obese individuals in the United States has increased, so too have related health care costs.

For some twenty years, experts emphasized that reducing the amount of fat in one's diet was the key to losing weight. And, supermarkets followed by stocking shelves with many varieties of low-fat and fat-free products. However, more recently, scientists and experts have turned their attention to carbohydrates, citing high amounts of sugar and white, starchy food, such as bread, pasta, and potatoes, as the culprits in the American diet. Many experts have encouraged Americans to adopt high-protein diets, consisting of more meat and eggs and less sugar and other digestible carbohydrates. As more and more Americans respond to these new dietary suggestions and adopt low-carbohydrate diets, there has been an increasing demand for low-carbohydrate versions of popular, highly cons to completely exclude all bread products from their diets.

Bread products are consumed in large volume in this country and have traditionally contained high levels of digestible carbohydrates. The carbohydrates found in bread are long chains of simple sugar molecules. These longer molecules are broken down by enzymatic hydrolysis into individual sugar molecules, which pass through the wall of the gastrointestinal tract and into the blood and lymph in a process called absorption. Carbohydrate absorption occurs primarily in the upper small intestine.

Wheat flour is the source of the carbohydrates and protein in a traditional bread product. Generally, making a traditional yeast-leavened bread involves mixing, kneading, and rising a dough, then shaping and baking the dough. Initially, the appropriate concentrations of wheat flour, yeast, and water are combined and mixed. A typical wheat flour is made from a hard wheat that has a gluten content of about 12 percent. As used in the art in connection with several kinds of flour, including wheat flour, barley flour, and rye flour, the term “gluten” actually relates to the component proteins of a particular flour which form gluten under processing. These component proteins vary among the different kinds of flour as do the concentrations of these component proteins (i.e., rye flour has a lower protein concentration than wheat flour); wheat flour contains the proteins gliadin and glutenin, barley flour contains the protein hordein, and rye flour contains the protein secalin. The component proteins of a flour, i.e., gliadin and glutenin in the case of wheat flour, form gluten upon mixing with water and upon agitation of the mixture. In the present invention, the gluten component is preferably wheat gluten.

The two protein components of wheat gluten, gliadin and glutenin, exist in the form of coiled or folded chains that are stabilized by intramolecular disulfide bonds, bonds between sulfur atoms on adjacent parts of a protein. When a dough is mixed, gliadin and glutenin are stretched and the relatively weak intramolecular disulfide bonds are broken. These intramolecular bonds can re-form during resting or new intermolecular disulfide bonds can form between the gliadin and glutenin proteins, resulting in the formation of gluten strands, which are stronger than the component proteins. As mixing progresses, more intramolecular bonds are broken, while more inter-molecular bonds are formed between gluten strands, creating a three-dimensional gluten network with gas retention capacity. Starches and fiber in the flour become enmeshed in this gluten network, as mixing progresses. The three-dimensional gluten network is a strong, elastic protein structure that imparts extensibility to the dough. Thus, when reference is made to the gluten content of wheat flour, what is meant is the sum of gliadin and glutenin content from which gluten is derived. And the terms “wheat gluten,” “rye gluten,” and “barley gluten” generally refer either to the precursor proteins contained in the grain, or the gluten as derived from these grains after processing.

Generally, when a dough becomes too thick to mix, it is kneaded by repeatedly pressing, folding, and turning it to further develop and stretch the gluten. The kneaded dough is then made into the shape of a loaf and allowed to proof, the process during which yeast cells replicate and grow. Most leavened breads are made with yeast, a microscopic organism that contains enzymes which catalyze the fermentation of sugars in the dough, converting them into alcohol, water, and carbon dioxide. The carbon dioxide gas released by the fermentation process becomes trapped in the strong and elastic gluten network, causing the dough to rise during proofing, in a process known as leavening. As the gluten network continues to capture carbon dioxide gas bubbles, small cells are formed throughout the dough. When the proofed dough is then baked, these small cells give the baked bread its characteristic cellular structure.

Conventional bread products contain high levels of wheat flour, which typically contains about 70 percent by weight net carbohydrates, 2.5 percent by weight dietary fiber, and about 1.5 percent by weight fat. Correspondingly, about 12 to about 16 grams of net carbohydrates are typically found in a 1 ounce (28.35 gram) slice of conventional bread, or between about 42 percent by weight and about 56 percent by weight net carbohydrates.

Others have produced dough and bread products having reduced levels of carbohydrates or higher levels of protein, as compared to conventional bread products. In U.S. Pat. App. No. 20030134023, Anfinsen teaches the addition of vital wheat gluten and hydrolyzed wheat protein, which together form a protein core, to whole wheat flour and other ingredients, to provide a low-carbohydrate bread product with structural, textural, and organoleptic properties reportedly comparable to those of conventional bread products and with about 3.0 grams of net carbohydrates per each 28.35 gram serving. Anfinsen also teaches a dough composition that contains an indigestible carbohydrate component.

Anfinsen also teaches a dough composition that contains a moisture managing agent, in addition to vital wheat gluten and hydrolyzed wheat protein, that may be selected from a milk-based protein hydrocolloid, a soy-based protein hydrocolloid, or a mixture thereof. Anfinsen states that a preferred soy-based protein hydrocolloid is a soy protein isolate and provides exemplary disclosure of a dough in which a soy-based protein hydrocolloid is present at a level of 1.87 percent by weight, together with 20.65 percent by weight of vital wheat gluten. Anfinsen also teaches a dough composition that contains a protease, preferably Fungal Protease 31. Anfinsen also teaches a great number of optional ingredients that may be included in the disclosed dough compositions. Among these many optional ingredients is a long list of protein sources that are not gluten-forming and do not function as hydrocolloids. The list includes soy protein.

British Pat. No. 1,472,738 teaches the addition of wheat gluten, whey protein concentrate, lactalbumin, and sodium soy isolate to high gluten flour and other ingredients, to provide a high-protein bakery product. This patent also teaches a dough composition that contains an acid fungal protease.

In U.S. Pat. No. 6,579,546, Jahnke teaches the addition of a dough additive composition comprising soy protein isolate, an enzyme, and cellulose to an unrisen pizza dough, to provide a microwavable, unrisen pizza dough composition. Jahnke also teaches a list of enzymes from which the enzyme component may be selected. This list of enzymes includes a protease, but states that the enzyme is preferably one capable of degrading carbohydrates. Jahnke also teaches the addition of the same dough additive composition to a combination of various ingredients, which includes gluten, to form a cinnamon roll concentrate, which is later mixed with flour and other ingredients to form a microwavable cinnamon roll dough.

While others have produced dough compositions and bread products with reduced levels of carbohydrates and/or increased levels of protein, there remains a need to develop a reduced carbohydrate dough with rheological properties comparable to those of conventional bread dough. Furthermore, there remains a need to develop bread products that have reduced levels of carbohydrates with structural, textural, and organoleptic properties that are at least generally comparable to those of conventional bread products.

### SUMMARY OF INVENTION

The present invention generally provides dough compositions containing additive gluten, a protease, a source of soy protein, and, optionally, an indigestible carbohydrate component. More specifically, the present invention provides dough compositions containing additive gluten, a protease, a source of soy protein, and, optionally, an indigestible carbohydrate component wherein the weight ratio of the soy protein to the additive gluten is at least about 0.2:1 and the net carbohydrate content is not greater than about 40% by weight. The dough compositions of the present invention also preferably contain flour. The present invention also provides dough compositions containing additive gluten, a protease, a source of soy protein, and, optionally, an indigestible carbohydrate component wherein the activity product of the dough composition is not greater than about 800, and typically is between about 20 and about 800.

Typically, the source of soy protein may be selected from the group consisting of soy protein isolate, soy protein concentrate, soy flour, textured soy protein, and combinations thereof.

The source of flour may be a wheat flour or a non-wheat flour, including potato flour, rye flour, barley flour, oat flour, soy flour, and r ice flour. Typically, the source of flour is wheat flour. The additive gluten is typically wheat gluten.

The present invention further provides bread products prepared by a process comprising baking any one of the dough compositions mentioned above. The present invention also includes baked bread products wherein the weight ratio of soy protein to additive gluten in the bread product is at least about 0.2:1, the net carbohydrate content is not greater than about 40% by weight, the moisture content is at least about 24% water by weight, and the texture is comparable.to the texture of a conventional bread product. The additive gluten is typically wheat gluten.

The present invention further provides a process for preparing any one of the dough compositions mentioned above including the steps of: preparing a sponge composition containing additive gluten and a protease; fermenting the sponge composition; preparing a dough precursor composition comprising a source of soy protein; combining the fermented sponge composition with the dough precursor composition; and allowing the combined composition to ferment. Typically, the source of soy protein may be selected from the group consisting of soy protein isolate, soy protein concentrate, soy flour, textured soy protein, and combinations thereof.

Other objects and features of this invention will be in part apparent and in part pointed out hereinafter.

### DETAILED DESCRIPTION OF THE INVENTION

Described herein are dough compositions containing additive gluten, a protease, and a source of soy protein. The dough compositions of the present invention are characterized by lower carbohydrate concentrations than conventional dough compositions. Advantageously, however, the rheological properties of these low-carbohydrate dough compositions are comparable to those of conventional bread dough compositions. Additionally, the dough compositions of the present invention may be used to make bread products that have increased levels of high quality soy protein, reduced carbohydrate content, and improved structural, textural, and organoleptic properties that are comparable to those of conventional bread products. Such high soy protein and low-carbohydrate bread products provide not only an appetizing, low-carbohydrate alternative to conventional bread, but a much healthier alternative to conventional bread.

The benefits of soy protein are well recognized. Soy protein has a positive effect on the cardiovascular system: soy protein intake may reduce cholesterol and the high levels of isoflavones found in soy protein may promote arterial health. The Food and Drug Administration has even recognized the health benefits of soy protein for the cardiovascular system by approving a health claim for soy protein for the reduction of heart disease. To qualify for the health claim, foods must contain at least 6.25 grams of soy protein per serving and fit other criteria, such as being low in fat, cholesterol, and sodium.

Soy protein also has a positive effect on the skeletal system. Soy protein does not reduce bone calcium content, unlike animal protein, which has been linked to bone calcium loss. The high levels of isoflavones found in soy protein may actually prevent bone loss and promote bone building. Soy protein also has a positive effect on the kidneys, in part because soy protein does not increase the workload on the kidneys. Thus, soy protein is well-tolerated by patients on hemodialysis who are suffering from chronic renal failure. Soy protein is also beneficial for diabetic (type 2) patients with nephropathy. Emerging research suggests that soy protein may also be effective for cancer prevention.

Overall, soy protein is a high quality protein. Sources of soy protein such as soy protein isolates and soy protein concentrates are low in fat and cholesterol free. For weight loss purposes, soy protein can reduce hunger and enhance satiety, helping one feel full longer. Thus, soy protein can promote healthy weight loss. Soy protein is an ideal ingredient for low-carbohydrate foods. Soy protein, in contrast to animal protein, can fulfill the need for increased protein in a low-carbohydrate diet without contributing cholesterol and high levels of fat, without increasing the workload on the kidneys, and without increasing the risk of cardiovascular disease as well as other diseases. A high soy protein and low-carbohydrate bread product is thus a healthy addition to a low-carbohydrate diet.

In order to make a reduced carbohydrate bread product, it is typically necessary to reduce the proportion of bread flour used to make the bread product. As mentioned above, a typical wheat flour used to make a conventional bread product contains about 70 percent by weight net carbohydrates, and a conventional bread product typically contains from about 12 to about 16 grams of net carbohydrates in a 1 ounce (28.35 gram) serving. Where the net carbohydrate content of a bread product is reduced by reducing the wheat flour content of the bread formulation, additive gluten, typically wheat gluten, may be included in the formulation to compensate for the reduced proportion of gluten provided by the wheat flour.

When additive gluten is added to a dough composition, as described above, a protease may also be included in the dough composition in order to partially break down the additive gluten and any other gluten present in the dough. By breaking down gluten, the protease contributes to the formation of a dough that had desirable rheological properties, i.e., comparable to those of conventional dough.

The dough compositions of the present invention generally include additive gluten, a protease, a source of soy protein, and, optionally, an indigestible carbohydrate component. These dough compositions have a net carbohydrate content of not greater than about 40 wt. %.

Additive Gluten

As discussed above, gluten, typically wheat gluten, is a necessary ingredient for proper dough leavening. When a dough is mixed, the component proteins of gluten, gliadin and glutenin, interact to form gluten strands. As mixing progresses, these gluten strands interact with each other to form a strong, elastic three-dimensional gluten network with gas retention capacity, and starches and fiber in the flour become enmeshed in this gluten network. As mentioned above, this gluten network allows for the formation of an extensible, viscous dough. Gluten must be present in the appropriate concentration in order to impart the above-described qualities to a dough and in order to form a resulting bread product with desirable structural properties.

Wheat gluten comes in several different forms, including in the form of naturally occurring gluten, the gluten which is naturally formed when wheat flour is mixed with water, in various hydrolyzed forms that vary in the degree of hydrolysis of the gluten, and in various concentrated forms, such as vital wheat gluten, isolated wheat protein, wheat gliadin, textured wheat protein, wheat glutenin, and gluten flour. Furthermore, some concentrated forms of gluten can vary according to protein concentration, including vital wheat gluten which is typically about 75% protein, isolated wheat protein which can be isolated to about 90% protein, and gluten flour. Vital wheat gluten is produced by hydromechanical processing (wet milling) of flour dough, a process in which a kneaded dough mass is continuously extracted to remove dispersed starch and other extractables, followed by drying of wet gluten. Specialized equipment is used to dry wet gluten to avoid denaturation and loss of baking function. Gluten flour is manufactured by adding vital wheat gluten to bread flour, i.e., in a ratio of 1:1. The dough and bread products of the present invention include an additive gluten component. Additive gluten as used herein refers to gluten that is provided in a form other than a flour that contains gluten-forming proteins in their naturally occurring condition and concentration, or which is generated in the dough from a source that is provided in such other form. Typically, the source of additive gluten contains gluten or gluten-forming proteins in a concentration greater than the natural concentration of gluten-forming proteins in flour. Typically, the additive gluten component comprises a form of wheat gluten with a protein concentration of at least about 50%. Preferably, the additive wheat gluten is not substantially hydrolyzed or denatured.

Because the wheat flour content is reduced to provide a low net carbohydrate product, additive gluten is incorporated into the dough and bread products of the invention in order to preserve the desired bread structure. The source of the additive gluten may be selected from the group consisting of vital wheat gluten, isolated wheat protein, wheat gliadin, wheat glutenin, gluten flour, and combinations thereof. Preferably, the additive gluten source is vital wheat gluten. In various embodiments of the present invention, the additive gluten content of the dough and bread is at least about 2.0% by weight. Typically, the additive gluten content is not greater than about 25.0% by weight. In various embodiments, the additive gluten content is between about 2.0% and about 25.0% by weight. In certain embodiments, the additive gluten content of the dough and bread is between about 8% by weight and about 15% by weight.

Generally, a dearth of gluten in a dough formulation results in a weak and sticky dough that is easily stretched but does not retain much gas and yields a crumbly baked bread product. However, an excess of gluten in a dough formulation results in the development of an increasingly tough, rubbery dough that is difficult to extend, stretch, and mix and a resulting bread product that has an increasingly gluten-like character, such as an open irregular crumb and a rubbery texture of both crust and crumb. Thus, varying the gluten concentration of a dough composition affects both the rheology of the dough, which may compromise productivity by making the dough difficult to process in high speed bread-making equipment, and the structure and texture of the resulting bread product. For example, combining additive gluten with a reduced flour dough, even when the concentration of the additive gluten is such that it merely compensates for the proportion of gluten provided by the flour, causes the dough to be more “inelastic”. This effect is due at least in part to the fact that additive gluten, i.e, vital wheat gluten, is more concentrated than naturally occurring gluten, which is balanced by the starches and fiber in flour. Thus, while the incorporation of additive gluten into a low carbohydrate bread product meets one need, i.e., the generation of a gluten network that provides the basic bread structure, it tends to produce a rubbery bread product with an open irregular crumb.

However, the adverse effects stemming from the incorporation of additive gluten into a dough formulation are at least partially overcome by adding a protease to the dough formulation. Incorporation of a significant fraction of soy protein may also help to impart desirable rheological properties to the bread product.

Protease

A protease is an enzyme that hydrolyzes the peptide bond between the amino group of one amino acid and the carboxyl group of the next amino acid in a protein, yielding lower molecular weight peptides. In the present invention, the protease is believed to weaken and/or break gluten strands in the dough. The protease may also partially hydrolyze some of the soy protein. Protease is added at a level sufficient to partially break down the gluten and generate a dough mix that can be processed using conventional equipment, more particularly using a high speed processing line. A preferred object is to provide an optimal combination of gluten and protease. More preferably, the combination produces a dough formulation having rheological properties in the conventional range, i.e., in the neighborhood of 500 Brabender Units. Most preferably, the combination produces a dough formulation that can be processed using a conventional low shear mixer, such as a Peerless or Hallmark Brand mixer, available from Peerless Machinery company, Sidney, Ohio. However, it is also preferred that the selection of the protease, namely the activity, concentration, and specificity thereof, and the fermentation conditions be controlled to limit the extent of gluten degradation, so that the gluten retains the capability of supporting the desired bread structure.

There are many different kinds of proteases. Each protease has an optimal pH range at which it operates, an optimal temperature range at which it operates, a specificity for a very limited number of substrates (often just one), and an activity (under stated conditions of pH, temperature, and substrate concentration) which is determined by measuring the rate of consumption of substrate or the rate of production of product. Some non-exhaustive examples of proteases that may be used in practicing the present invention include acid proteases, aminopeptidases, carboxypeptidases, sulfhydryl proteases, alkaline proteases, serine proteases, neutral proteases, or endo and exo-proteases. One skilled in the art could select an appropriate protease based on the pH range and the temperature range of a dough composition, the desired substrate, e.g., if the substrate is gluten, one would choose a protease with a specificity for gluten, and the desired activity of the protease. In certain preferred embodiments, the protease is Protease A “Amano” 2, available from Amano enzymes, Elgin, Ill.

The mathematical combination of the activity and the concentration of a protease is defined here as the activity product of a dough formulation, expressed by the equation:
Activity Product=(activity of protease (in units/gram))(concentration of protease (% total weight of ingredients))
Typically the activity product is not greater than about 800. In certain preferred embodiments, the activity product is between about 20 and about 800. Also, typically, a protease is selected that has specificity for gluten as a substrate. It is understood that the “activity product” is an essentially artificial expression which may not necessarily reflect the actual activity of the protease in the dough composition, i.e., effective activity in the dough may possibly be affected by various interactions, and in any event may not necessarily be a linear function of enzyme concentration therein. However, the “activity product” is nevertheless understood to provide a useful mathematical index that affords a general practical guide to the level at which a given protease may suitably be incorporated into a dough composition.
Soy Protein

In addition to additive gluten and a protease, the present invention also comprises a source of soy protein. In general, protein is a macronutrient that supplies amino acids to the body and is used for the formation of muscle and other protein-containing components in the body, including immunoglobulins, albumin, and enzymes. The body synthesizes non-essential amino acids but cannot synthesize essential amino acids, which must be supplied by food sources. All plant and animal proteins have approximately the same 20 amino acids. It is the proportion of each amino acid that varies as a characteristic of the protein source. The nutritional quality of any protein relates to its amino acid composition, digestibility, and ability to supply the essential amino acids in the proportions required by the species consuming the protein. The nutritional quality of soy protein is high: soy protein has a favorable amino acid composition, is highly digestible, and contains appropriate proportions (the proportions required by children age 2 and older and by adults) of all 9 essential amino acids.

Soy protein comes in three major forms, including soy flours, soy protein concentrates, and soy protein isolates. Generally, during the processing of soybeans, the beans are first cleaned, then conditioned, cracked, dehulled, and rolled into flakes. Next, soy oil is removed from the flakes. The flakes are then dried, creating what are referred to as defatted soybean flakes. These defatted soybean flakes are the basis for the three major forms of soy protein mentioned above. Defatted soy flour is made by grinding defatted soybean flakes. When soy oil is not removed during processing, a full-fat soy flour may be produced. Alternatively, when a fraction of soy oil is removed during processing, a low-fat soy flour is produced, which has about ⅓ of the fat of a full-fat soy flour. Soy flours are between about 40% and about 55% protein by weight, with full-fat soy flours containing about 40% protein by weight, low-fat soy flours containing about 52% protein by weight, and defatted soy flours containing about 55% protein by weight, and contain the carbohydrate components of the soybean. Defatted soy flour can be used to make textured soy flour, which is produced by passing defatted soy flour through an extrusion cooker. Textured soy flour has a chewy texture when hydrated and is commonly used as a meat extender. Soy protein concentrates are made by processing defatted soy flakes to remove a portion of the water-soluble carbohydrates from the soy flakes. Soy protein concentrates contain from about 65% up to about 90% protein by weight and up to 20% dietary fiber by weight. Soy protein concentrates can be extruded to make textured soy protein concentrates, which are found in many different forms and sizes. When hydrated, they have a chewy texture and contribute to the texture of meat products. The term “textured soy protein” (TSP) refers broadly to textured soy flour, textured soy protein concentrates, and textured soy protein isolates. Soy protein isolates are prepared by a process that includes water extraction to remove a very high proportion of carbohydrates, including dietary fiber, from defatted soy flakes. The soy protein is then precipitated and dried. Soy protein isolates are nearly carbohydrate and fat-free, with no characteristic “beany” flavor. Soy protein isolates prepared this way are at least 90% protein by weight. Textured soy protein isolates are also available. Both soy protein isolates and soy protein concentrates contain more isoflavones if, during processing, carbohydrates are extracted from the starting soy flakes with appropriate quantities of water, rather than alcohol.

In the present invention, the soy protein potentially serves several functions. Soy protein buttresses the additive gluten in enhancing the protein content of the bread. Additionally, without being bound to any particular theory, it is believed that the soy protein also contributes to the partial degradation of gluten, which, as discussed above, is necessary to provide the desired rheology of the dough. The soy protein molecule apparently includes certain peptide regimes that have a proteolytic effect on the gluten. Thus, in combination with a protease, the presence of soy protein allows additive gluten to be substituted in substantial part for the gluten of wheat flour, while preserving desired rheology so that the resultant low carbohydrate product not only has good structure and organoleptic properties, but also is subject to being manufactured using high speed processing equipment.

While gluten contributes to the total protein content of the bread, provides a stronger baked bread product, and may be lower in cost than soy protein, soy protein has various further advantages over gluten, including water retention: For example, soy proteins are larger than gluten proteins, hold more water and, thus, generate higher “yield,” i.e., more bread per unit weight of protein in the formulation. A bread product containing soy protein may also exhibit a longer shelf life and may have a favorable texture, mouth feel, and overall quality, as perceived by the consumer. Soy protein also affords health benefits superior to any that may be provided by gluten. As mentioned above, where the soy content of a product is 6.25 grams per serving or more, a health benefit may be claimed on the label, according to the FDA.

Furthermore, the presence of soy protein improves the amino acid profile and protein quality score of a bread product. The amino acid profile of a bread product describes the proportion of each of the nine essential amino acids, histidine, isoleucine, leucine, lysine, methionine (which can be partially substituted for by cysteine), phenylalanine (which can be partially substituted for by tyrosine), threonine, tryptophan, and valine, in the bread product, in mg/g protein. The amino acid score or protein quality index of a bread product compares the product's amino acid profile to an ideal profile, as developed by the Food and Nutrition Board (FNB) and the Institute of Medicine (IOM) (both part of the National Academies of Sciences) and described in the “Dietary Reference Intakes (DRI) for Energy, Carbohydrate, Fiber, Fat, Fatty Acids, Cholesterol, Protein, and Amino Acids (Macronutrients) (2002).” Estimated average requirements for amino acids were used to develop the ideal amino acid profiles for various age groups, based on the recommended intake of dietary protein. For example, the ideal amino acid profile for children aged 1 year and up and older age groups is shown in the table below, in the column labeled “ideal ratio.” The protein quality score of a bread product, not to be confused with the protein quality index, is based on the proportion of the limiting essential amino acid, the amino acid present at the lowest percentage of its ideal proportion, i.e., if lysine is present at a proportion of 39.37 mg/g of protein, with the ideal proportion being 51 mg/g of protein, or 77% of the ideal proportion, and this is the lowest such percentage of any essential amino acid found in the product, then the product's protein quality score (based on the limiting amino acid lysine) is 77%. Typically, a bread product of the present invention has a protein quality score of at least 42% (with lysine as the limiting amino acid). Typically, a bread product of the present invention has the following amino acid profile:

| | | | | Amino Acid |
|---|---|---|---|---|
| | | | Ideal | Score (ratio |
| | | | Ratio² | (mg/g protein)/ |
| | Ratio (mg/g | Ratio (mg/g | (mg/g | ideal ratio |
| Amino Acid | protein) | dough) | protein) | (mg/g protein)) |
| Histidine | 14.73-29.00 | 3.14-6.97 | 18 | 82%-161% |
| Isoleucine | 18.91-48.67 | 3.97-10.58 | 25 | 76%-195% |
| Leucine | 29.90-86.36 | 6.25-18.13 | 55 | 54%-157% |
| Lysine | 21.54-48.65 | 4.58-13.06 | 51 | 42%-95% |
| Methionine + | 19.70-40.19 | 4.66-9.90 | 25 | 79%-161% |
| Cystine | | | | |
| Phenylalanine + | 49.74-97.40 | 10.54-23.68 | 47 | 106%-207% |
| Tyrosine | | | | |
| Threonine | 19.62-39.02 | 4.17-9.61 | 27 | 73%-145% |
| Tryptophan | 5.51-13.04 | 1.16-2.88 | 7 | 79%-186% |
| Valine | 28.38-55.82 | 6.02-13.38 | 32 | 89%-174% |

²Ideal ratio based on the “Dietary Reference Intakes (DRI) for Energy, Carbohydrate, Fiber, Fat, Fatty Acids, Cholesterol, Protein, and Amino Acids (Macronutrients) (2002).”

In the present invention, the soy protein source is preferably soy protein isolate. In certain formulations of the present invention, soy protein isolate can be partially substituted with soy protein concentrate. Soy protein isolate can also be partially substituted with textured soy protein isolate and/or textured soy protein concentrate. In various embodiments, the soy protein content of the dough and bread is at least about 3.0% by weight, typically between about 3.0% by weight and about 20.0% by weight. In certain embodiments, the soy protein content of the dough and bread is between about 5.0% by weight and about 12.0% by weight. In certain embodiments, the water content of the dough composition is estimated to be at least about 35% water by weight. In certain preferred embodiments, the water content of the dough composition is estimated to be between about 35% water by weight and about 55% water by weight.

Soy Protein: Additive Gluten

An object of the various preferred embodiments of the present invention is to provide a dough composition and a baked bread product with an optimal weight ratio of soy protein to additive gluten. As discussed above, varying the gluten content, more particularly the additive gluten content, of a dough formulation can affect the rheology of the dough as well as the texture, structure, moisture content, and nutritional value of the resulting bread product. The present invention, therefore, seeks to provide a ratio of soy protein to additive gluten that maximizes the benefits of gluten and soy protein, while minimizing the adverse effects of gluten on the dough and the resulting bread product.

Typically, the weight ratio of soy protein to additive gluten is at least about 0.2:1. Preferably, the weight ratio of soy protein to additive gluten is at least about 0.3:1. Most preferably, the weight ratio of soy protein to additive gluten is at least about 0.4:1. These ratios allow the bread to have a gluten content sufficient to provide desired structural and textural properties, while avoiding the negative effects of excess gluten in bread processing.

The weight ratio of soy protein to additive gluten may also contribute to the amino acid profile, which is described above in the discussion of the soy protein component, of the dough composition and the resulting bread product.

Indigestible Carbohydrate

The dough compositions of the present invention may optionally include an indigestible carbohydrate component, in order to reduce the net carbohydrate content of the resulting bread product. The indigestible carbohydrate component comprises a dietary fiber, as defined by the American Association of Cereal Chemists (AACC), or a mixture of different dietary fibers. There has been a great deal of debate regarding the definition of dietary fiber. The definition of dietary fiber varies throughout the world and even within the U.S., with competing definitions emerging from the Food Nutrition Board (FNB) of the Institute of Medicine of the National Academies of Science and the AACC. The AACC, a scientific organization that has long been involved in research on dietary fiber, has criticized the FNB's definition of dietary fiber and offered its own definition:
“Dietary fiber is the edible parts of plants or analogous carbohydrates that are resistant to digestion and absorption in the human small intestine with complete or partial fermentation in the large intestine. Dietary fiber includes polysaccharides, oligosaccharides, lignin, and associated plant substances. Dietary fibers promote beneficial physiological effects including laxation, and/or blood cholesterol attenuation, and/or blood glucose attenuation.”
   Analogous carbohydrates are defined as “those materials, not necessarily intrinsic to a part of a plant as consumed, but that exhibit the digestion and fermentation properties of fiber.” The definition of analogous carbohydrates includes carbohydrates that are not naturally occurring but have “structures analogous to those of naturally occurring dietary fibers” and “demonstrate the physiological properties of the respective materials to which they are analogous.” Such analogous carbohydrates are produced by chemical or physical modification of a naturally occurring starch to reduce the digestibility of the starch or by synthesis. The definition of “analogous carbohydrates” also includes some resistant starches, which can occur naturally or may be manufactured, namely those resistant starches that consistently resist digestion (i.e, not those that are rendered digestible upon cooking or those found in immature fruits and vegetables that are rendered digestible upon ripening of the fruit or vegetable). Analogous carbohydrates thus include indigestible dextrins, i.e., resistant maltodextrins (from corn or other sources) and resistant potato dextrins, which are typically produced by acid or thermal treatments of starch hydrosylates that render the hydrosylates or portions thereof indigestible, synthesized carbohydrate compounds, i.e., polydextrose, methyl cellulose, and hydroxypropylmethyl cellulose, and resistant starches, namely only those starches that are resistant to digestion in humans and resistant to digestion in properly designed analytical tests that include gelatinization steps to simulate cooking and processing. Examples of resistant starch include retrograded amylose, physically trapped starch, digestion-resistant starch granules, and fragments of chemically and thermally modified starches.

The AACC definition of dietary fiber states that dietary fiber includes “polysaccharides [and] oligosaccharides.” The polysaccharides and oligosaccharides of the AACC definition include cellulose, modified cellulose, hemicellulose, i.e., arabinoxylans and arabinogalactans, polyfructoses, i.e, inulin and oligofructans, galactooligosaccacharides, gums, mucilages, and pectins. Lignin, along with cellulose and hemicellulose, is an integral part of the cell walls of plant cells and is a complex polymer of phenylpropane units. And, finally, the associated plant substances, namely substances associated with lignin, cellulose, and hemicellulose in plant cell walls, mentioned in the above definition include waxes, phytate, cutin, saponins, suberin, and tannins.

Specific examples of dietary fiber sources include gum arabic, carboxymethylcellulose, guar gum, gellan gum, gum acacia, citrus pectin, low and high methoxy pectin, oat and barley glucans, carrageenan, psyllium, soy polysaccharide, xylooligosaccharide (XO), alpha glucooligosaccharide (GO), fructooligo-saccharides (FO), trans galactosyl oligosaccharides (TO), hydrolyzed inulin, lactosucrose, oat hull fiber, pea hull fiber, soy hull fiber, soy cotyledon fiber, sugar beet fiber, corn bran, hydrolyzed forms of the listed fibers, encapsulated forms of the listed fibers, and any combination thereof. Numerous commercial sources of dietary fibers are readily available and known to one practicing in the art. Gum arabic, hydrolyzed carboxymethyl-cellulose, guar gum, pectin and the low and high methoxy pectins are available from TIC Gums, Inc. of Belcamp, Md. and Gum Technologies Corp. of Tucson, Ariz. Novelose® 260 is a resistant cornstarch that is available from National Starch & Chemical of Bridgewater, N.J. Fiberstar™ 70 is a resistant wheat starch that is available from Midwest Grain Products, Atchison, Kans. The xylooligosaccharides (XOs) are available from Suntory Limited of Osaka, Japan. The alpha glucooligosaccharides (GOs) are available from Solabia of Pantin Cedex, France. The fructooligosaccharides (FOs) are available from Golden Technologies Company of Golden, Colo. The trans galactosyl oligosaccharides (TOs) are available from Yakult Honsha Co. of Tokyo, Japan. The oat and barley glucans are available from Mountain Lake Specialty Ingredients, Inc. of Omaha, Nebr. Psyllium is available from the Meer Corporation of North Bergen, N.J. Carrageenan is available from FMC Corporation of Philadelphia, Pa.

In certain embodiments, the indigestible carbohydrate component comprises an analogous carbohydrate, as defined above. Typically, the indigestible carbohydrate component comprises a resistant starch. In certain preferred embodiments, the indigestible carbohydrate component is selected from the group consisting of resistant cornstarch, i.e., Novelose® 260, and resistant wheat starch, i.e., Fiberstar™ 70.

In a low net carbohydrate bread, the bulking agent essentially displaces a significant portion of wheat flour from the dough formulation, resulting in the need for additive gluten as discussed above. Typically, the additive gluten merely compensates for the reduced proportion of gluten provided by the wheat flour, rather than increasing the total gluten content of the bread. If desired, additive gluten may be incorporated at a level which increases the total gluten content as compared to a conventional bread product; but, this is not normally necessary. As further discussed above, the potentially net adverse effect of additive gluten on dough rheology may be compensated for by the incorporation of a protease and soy protein which may partially degrade the additive gluten. The rheology of low net carbohydrate dough formulations, particularly those containing a bulking agent, may also be controlled in part by adjusting the concentration of liquids, more particularly water, in the formulation. Generally, a modestly increased water content is helpful in preventing the dough from becoming unduly rubbery and “inelastic”.

Other Optional Ingredients

The dough compositions of the present invention may optionally include a leavening agent. A leavening agent is an organism or substance that causes a dough to rise by evolving carbon dioxide or other gases that become trapped as bubbles within the dough. Commonly used leavening agents include yeast, baking powder, and baking soda. Baking soda and baking powder are typically used to leaven quick breads, cookies, and muffins. Leavening agents are typically present at a concentration of about 0.25% by weight to about 2% by weight.

The dough compositions of the present invention may optionally include dough conditioners. Generally, dough conditioners help to compensate for ingredient and process variability in bread manufacturing, resulting in consistently high quality bread products. The dough conditioner category includes oxidizing agents, reducing agents, and emulsifiers. Oxidizing agents remove hydrogen atoms from sulfur-hydrogen (sulfhydryl) linkages in gluten and thus make more sulfur available for gluten-strengthening, intermolecular disulfide bonds. Commonly used oxidizers are azodicarbonamide (ADA), which can be used at up to 45 ppm in the United States, and ascorbic acid, or vitamin C, for which there is no usage limit in the United States. Ascorbic acid is commonly used at about 75 ppm.

Reducing agents have the opposite effect of oxidizers: reducing agents disrupt disulfide bonds, both intermolecular and intramolecular disulfide bonds, resulting in the weakening of a protein structure. Reducing agents allow for the proteins in dough to unfold quickly, with less mixing, by disrupting intramolecular disulfide bonds. Thus, reducing agents can contribute to the softening of gluten, which is desired in certain doughs, like biscuit dough. Reducing agents can also be used in conjunction with a slow-acting oxidizer, like ascorbic acid, to reduce mixing time. In this case, the oxidizing agent promotes intermolecular disulfide bonds between unfolded proteins. The most commonly used reducing agent, L-cysteine, works very quickly. Other reducing agents include sulfites, bisulfates, and reduced glutathione. L-cysteine is typically used at about 10 ppm to about 90 ppm and bisulfates are typically used at about 20 ppm to about 100 ppm.

Emulsifiers have two major functions in dough, strengthening and crumb softening. It is believed that, when functioning as a crumb softeners, emulsifiers form complexes with amylose in the dough and interfere with the recrystallization of amylose, which retards the firming rate. It is believed that, when functioning as dough strengtheners, emulsifiers improve the binding of gluten strands to each other, thus improving the gas retention capacity of the three-dimensional gluten network. Among the most effective emulsifiers in terms of crumb softening is a dispersible form of monoglycerides (saturated types), typically used at 0.5% to 1.0% of the flour weight. Emulsifiers that contribute to dough strengthening include ethoxylated mono- and diglycerides (EMG), soy lecithin, and polysorbates (PS). Emulsifiers that contribute to both dough strengthening and crumb softening include calcium stearoyl lactylate (CSL), sodium stearoyl lactylate (SSL), diacetyl tartaric acid esters of monoglycerides (DATEM), and succinylated monoglycerides (SMG). Soy Lecithin also contributes to the production of a crust that retains its crispness qualities longer; soy lecithin is thus a commonly used emulsifier in baguettes and other crusty breads. Emulsifiers are typically present at a concentration of about 0.25% by weight to about 0.5% by weight.

Another optional ingredient that may be included in various embodiments of the present invention is a carbohydrase. A carbohydrase is an enzyme that catalyzes the hydrolysis of a carbohydrate. There are a variety of carbohydrases, including amylases, enzymes that cleave starches into smaller units, xylanases, enzymes that digest xylan (a heteropolymer of the pentose sugar xylose), and cellulases, which break down cellulose. In certain embodiments of the present invention, the carbohydrase is selected from the group consisting of amylase, xylanase, and combinations thereof. A maltogenic amylase is available from Novozymes North America, Inc., Franklinton, N.C., under the trademark Novamyl®. A xylanase is available from Danisco Cultor USA, New Century, Kans., under the trade designation Grindamyl H849. Carbohydrases are typically present at a concentration of about 0.005% by weight to about 0.25% by weight.

In addition to a carbohydrase, the dough compositions of the present invention can also optionally include a transglutaminase. A transglutaminase is an enzyme that catalyzes the intermolecular and/or intramolecular cross-linking of proteins. Specifically, transglutaminases catalyze the formation of a covalent bond between a free amine group of a lysine and a gamma-carboxamid group of a glutamine. A transglutaminase is available from AB Enzymes, Fort Mill, S.C., under the trade designation Veron TG. Transglutaminases are typically present at a concentration of about 0.005% by weight to about 0.25% by weight.

The dough compositions and bread products of the present invention can optionally include vitamins and/or minerals. Vitamins and minerals are essential for good health. One skilled in the art appreciates that dietary requirements have been established for certain vitamins and minerals which are necessary for proper functioning of the body. Some foods, like fruits and vegetables, naturally contain various vitamins and minerals. Other foods, like milk and bread, must be “enriched” with various vitamins and minerals. To “enrich” a bread product, nutrients, such as vitamins and minerals, are added to a dough composition in concentrations sufficient to compensate for the loss of these ingredients during baking of the dough and storage of the bread products. Vitamins and minerals that are typically added to an “enriched” bread product include thiamin, riboflavin, niacin, folic acid, iron, and calcium. When nutrients which are not initially present in a dough composition are added to the dough composition, the resultant bread product is “fortified”. Vitamins that can be used to “fortify” a bread product include vitamins A, B₁, B₂, B₆, B₁₂, C, D, E, K, beta-carotene (vitamin A precursor), biotin, folic acid, pantothenic acid, and niacin. Minerals include magnesium, calcium, sodium, potassium, chloride, phosphorous, the trace minerals—iron, zinc, manganese, copper, and iodine, and the ultra trace minerals—chromium, molybdenum, selenium. Also, phytonutrients, which are nutritionally-important compounds found only in plants, may optionally be included in the dough compositions of the present invention. The concentrations of vitamins and minerals present in the dough compositions of the present invention, prior to enrichment, differ from the concentrations of vitamins and minerals present in conventional dough compositions, prior to enrichment, due in large part to the soy protein content of these dough compositions. For example, as mentioned above, isoflavones (classified as phytonutrients) are found almost exclusively in soy and soy proteins. Thus, the concentrations of vitamins and minerals added to a bread product of the present invention in order to “enrich” it (or to “fortify” it) vary from the concentrations of these nutrients added to “enrich” a conventional bread product.

The dough compositions and bread products of the present invention can also optionally include sweetening agents, flavorings, and/or salt. Natural sweetening agents that may be used include sucrose (table sugar), dextrose, fructose, maltose, molasses, honey, maple syrup, corn syrup, cane juice, malt syrup, fruit juice concentrate, and rice syrup. Artificial sweeteners may also be used. Artificial sweeteners that are commonly used include aspartame, sucralose, acesulfame K, and polydextrose. A preferred sweetening agent is sucralose. Flavorings that are commonly used in bread products include bread type flavor, oat flavor, wheat flavor, butter flavor. One skilled in the art could select an appropriate flavor based on the desired resulting bread product.

The dough compositions of the present invention may optionally include a hydrocolloid and/or a humectant. Generally, hydrocolloids are colloidal ingredients that readily absorb water and can affect the texture of bread. Most hydrocolloids are carbohydrate polymers; as mentioned above, protein hydrocolloids, such as soy-based protein hydrocolloid or milk-based protein hydrocolloid, also exist and can be used in the art of bread making. Many hydrocolloids have a negligible impact on blood sugar and do not contribute or contribute only slightly to the net carbohydrate content of a bread product. For example, hydrocolloids such as gums and pectin fall within the AACC definition of dietary fiber and thus do not contribute to the net carbohydrate content of a bread product. Some hydrocolloids do have an impact on blood sugar and can contribute to the net carbohydrate content of a bread product. However, a hydrocolloid is generally present at such a low concentration in a bread product that it has substantially no effect on the net carbohydrate content of a bread product. A variety of hydrocolloids may be included in the dough compositions of the present invention. A preferred hydrocolloid is xanthan gum. A humectant is a substance that has an affinity for water and has the ability to stabilize the water content of a product. A humectant buffers against humidity fluctuations and helps maintain the moisture content of a product within a narrow range. Preferred humectants do not contribute or contribute only slightly to the net carbohydrate content of a bread product. An example of a preferred humectant is glycerol, also referred to as glycerine. Glycerol has a negligible impact on blood sugar, as discussed below, and therefore does not contribute to the net carbohydrate content of a product.

The dough compositions and bread products of the present invention may optionally include a fat ingredient, such as soybean oil, butter, or margarine. Such fats are well-known in the art and a suitable fat ingredient can be selected by one of skill in the art. A preferred fat ingredient is soybean oil. Fat ingredients are typically present at a concentration of about 1% by weight to about 50% by weight.

The dough compositions and bread products of the present invention may also optionally include preservatives to extend the shelf lives of the bread products. Preservatives typically used in bread products include ascorbic acid, calcium propionate, calcium sorbate, citric acid, sodium erythorbate, and mixtures thereof. A preferred preservative is selected from the group consisting of ascorbic acid and calcium propionate.

Process Steps

The present invention also provides a process for preparing a dough composition containing additive gluten, a protease, a source of soy protein, and, optionally, an indigestible starch. A preferred form of the process comprises several steps. A sponge composition containing the additive gluten and the protease is prepared and allowed to ferment. A dough precursor composition comprising the soy protein source is also prepared. The fermented sponge composition is combined with the dough precursor composition and the combined composition is allowed to ferment. In this combined composition, the weight ratio of the soy protein to the additive gluten is preferably at least about 0.2:1 and the net carbohydrate content of the combined composition is not greater than about 40 wt. %. The soy protein source is preferably selected from the group consisting of soy protein isolate, soy protein concentrate, textured soy protein, and combinations thereof. In certain embodiments of this process, the dough composition has an activity product that is not greater than about 800. In certain preferred embodiments of this process, the activity product is between about 20 and about 800. Furthermore, in accordance with the present invention, baked bread products may be prepared by a process comprising baking a selected dough composition containing additive gluten, a protease, and a source of soy protein. Preferably, the soy protein source is selected from the group consisting of soy protein isolate, soy protein concentrate, textured soy protein, and combinations thereof. Such baked bread products have net carbohydrate contents not greater than about 40 wt. %. In certain embodiments, such a baked bread product has a moisture content of at least about 20% water by weight. Typically, such a baked bread product has a texture and a shelf life that are comparable to the texture and shelf life of a conventional bread product. Advantageously, such a baked bread product has a weight ratio of soy protein to additive gluten of at least about 0.2:1. In certain embodiments, such a baked bread product has a weight ratio of soy protein to additive gluten of at least about 0.3:1. Preferably, such a baked bread product has a weight ratio of soy protein to additive gluten of at least about 0.4:1.

Definitions

As used herein:
a. “Bread” or “bread product” includes ordinary loaf breads, buns, pizza, rolls, bagels, English muffins, croissants, bread sticks, pita breads, bagels, sweet breads, and doughnuts.
b. “Conventional bread products” or “traditional bread products” refer to conventional white loaf breads. An example of a conventional white loaf bread is a commercial white loaf bread like Butternut® brand enriched white bread (Interstate Brands Corp., Kansas City, Mo.), with net carbohydrates (14 grams), protein (2 grams), and fat,(1 gram) per each 30 gram slice.
c. The term “net carbohydrates” refers to the total carbohydrate content of a product less the content of carbohydrates that have a negligible impact on blood sugar, including indigestible carbohydrates, as described above, sugar alcohols, and glycerine, also known as glycerol. Net carbohydrates can be expressed in grams/serving or percent by weight ((grams/grams in one serving)(100)). There is currently no official FDA definition for “net carbohydrates” and there are no FDA guidelines regarding what constitutes a “low-carbohydrate” product. There is some debate over the above definition, namely in regard to sugar alcohols. The various sugar alcohols have different effects on blood sugar, and there is thus some question about whether all sugar alcohols can be subtracted when calculating net carbohydrates. However, the above is a generally accepted definition for net carbohydrates and is used consistently herein.

Altogether, the present invention advantageously provides dough compositions and bread products characterized by lower carbohydrate concentrations than conventional dough compositions and bread products and increased concentrations of high quality soy protein. Advantageously, however, the rheological properties of the low-carbohydrate dough compositions and the structural, textural, and organoleptic properties of the bread products are comparable to those of conventional dough compositions and bread products. The high soy protein and low-carbohydrate bread products provide not only an appetizing, low-carbohydrate alternative to conventional bread, but a much healthier alternative to conventional bread.

### EXAMPLES

The following examples, while not limiting, serve to further illustrate the invention.

### Example 1

A low-carbohydrate, white bread, with 9 g of net carbohydrates per 28 g serving or 32% by weight of net carbohydrates, is produced from the dough formulation shown in Table 1. The sponge ingredients are mixed in a water-cooled jacketed mixing bowl maintained at 70° F. for about 30 seconds on #1 speed, approximately 61 rpm, and then for about 4 minutes on #2 speed, approximately 113 rpm, using a Hobart A200 mixer (a conventional low shear mixer). The mixed sponge is placed in a greased plastic container, covered with plastic wrap, and allowed to ferment for about 3 hours, at a temperature of about 80° F. The dough precursor ingredients are mixed for about 15 seconds on #1 speed, approximately 61 rpm. The fermented sponge is then added to the dough precursor and the combination is then mixed for about 15 seconds on #1 speed, approximately 61 rpm, and then for about 3 minutes on #2 speed, approximately 113 rpm to form the final dough mixture. The dough is then placed into a plastic container, covered, and allowed to rest in a cabinet for 10 minutes. The combination is then divided into 540 gram dough pieces. These dough pieces are rounded by hand into balls. Then, these rounded dough pieces are passed through an open sheeter set at 5/32 inches followed by a second pass through the sheeter set at ⅛ inches. A sheeter flattens the dough balls into flat dough pieces; as dough balls pass through the sheeting roll(s), gas cells in the dough balls are disrupted and the dough is degassed. After the second pass through the sheeter, flat dough pieces are folded into thirds by hand, much like a letter is folded into thirds before it is placed in an envelope. The folded dough pieces are then rested on a laboratory bench top for 10 minutes. Each dough piece is molded, or shaped, into a log-shaped loaf of dough using a Moline Model 100 sheeter-molder, set at setting 5 (The Moline Company, Duluth, Minn.). The log-shaped dough pieces are then placed into pans and proofed to template, or allowed to rise until the dough reaches a height of 1 inch above the top of the pan (the height of the selected template). The dough pieces are allowed to proof for no more than 70 minutes. The dough pieces are then baked at 400° F. for 19 minutes in an electric powered reel oven.

TABLE I

| | | Total % |
|---|---|---|
| | | (proportion |
| | Flour % (proportion of | of ingredient |
| | ingredient relative to weight | relative |
| | of total flour, with | to weight |
| | proportion of total flour set | of total dough |
| Ingredient | at 100%) | ingredients) |
| SPONGE: | | |
| Bread Flour | 61.54 | 22.61 |
| Vital Wheat Gluten | 23.08 | 8.48 |
| Instant Yeast | 2.46 | 0.90 |
| Yeast Food | 0.77 | 0.28 |
| Ascorbic acid | 0.62 | 0.23 |
| Protease | 0.0029 | 0.001 |
| Water | 52.31 | 19.21 |
| DOUGH PRECURSOR: | | |
| Bread Flour | 38.46 | 14.13 |
| Instant Yeast | 0.62 | 0.23 |
| Isolated Soy Protein | 11.54 | 4.24 |
| Soybean Oil | 4.08 | 1.50 |
| Dough Conditioner | 0.51 | 0.19 |
| Monoglycerides | 0.75 | 0.28 |
| Sugar | 12.31 | 4.52 |
| Sodium Stearoyl Lactylate | 0.51 | 0.19 |
| DATEM | 0.51 | 0.19 |
| Salt | 2.46 | 0.90 |
| Soy Fiber | 1.50 | 0.55 |
| Amylase | 0.02 | .007 |
| Bread Flavor | 0.51 | 0.19 |
| Calcium Propionate | 0.51 | 0.19 |
| Aromatic 305:3 | 0.25 | 0.09 |
| Water | 56.92 | 20.91 |
| Total | 272.24 | 100.00 |

The bread flour is available from Cahokia Flour Company, St. Louis, Mo., under the trade designation Lady Ellen Hotel and Restaurant Flour. The vital wheat gluten is available from Midwest Grain Products, Atchison, Kans. The instant yeast ingredient is available from Lesaffre Yeast Corporation, Milwaukee, Wis., under the trademark SAF Instant™ Red. The yeast food is available from American Ingredients, Anaheim, Calif., under the trade designation Arco Yeast Food. The ascorbic acid is available from Cain Food Industries, Dallas, Tex., under the trade designation Ascorbo-120. The protease is available from Amano enzymes, Elgin, Ill., under the trade designation Protease A “Amano” 2. The isolated soy protein is available from The Solae Company, St. Louis, Mo., under the trademark Supro® 661. The soybean oil is available from Bakemark, St. Louis, Mo., as Bakemark Salad Oil, item #1546400. The dough conditioner, a blend of soy flour, calcium sulfate, salt, dicalcium phosphate, calcium peroxide, and ammonium phosphate, is available from Archer Daniels Midland, Decatur, Ill., under the trade designation Improved Paniplus M. The monoglycerides are available from Archer Daniels Midland, Decatur, Ill., under the trade designation Elasdo 70. The sodium stearoyl lactylate is available from American Ingredients, Kansas City, Mo., under the trade designation Emplex. The DATEM is available from Danisco Cultor USA, New Century, Kans., under the trademark Panodan® 205K. The soy fiber is available from The Solac Company, St. Louis, Mo., under the trademark Fibrim® 1260. The enzyme is available from Novozymes North America, Inc., Franklinton, N.C. under the trade designation Novamyl®. The bread flavor is available from Gold Coast Ingredients Inc., Commerce, Calif. The calcium propionate is available from Burns Philip Food Inc., Fenton, Mo., under the trade designation Benchmate Brand Calcium Propionate. The emulsifier is available from Aromatic, Stockholm, Sweden, under the trade designation Aromatic 305:3.

### Example 2

A low-carbohydrate whole wheat bread, with 6 g of net carbohydrates per 28 g serving or 21% by weight of net carbohydrates, is produced from the dough formulation shown in Table II. This whole wheat dough is made with largely the same ingredients as the dough of Example 1 (a different flour was used and is noted below) and according to the procedure disclosed in Example 1, except that the dough is baked for 20 minutes.

TABLE II

| | Flour % | |
|---|---|---|
| | (proportion of | |
| | ingredient relative | Total % (proportion |
| | to weight of total | of ingredient |
| | flour, with proportion | relative to weight |
| | of total flour set | of total dough |
| Ingredient | at 100%) | ingredients) |
| SPONGE: | | |
| Whole Wheat Flour | 63.64 | 19.27 |
| Vital Wheat Gluten | 36.36 | 11.01 |
| Instant Yeast | 2.91 | 0.88 |
| Yeast Food | 0.91 | 0.28 |
| Ascorbic Acid | 0.73 | 0.22 |
| Protease | 0.0023 | 0.001 |
| Water | 67.27 | 20.37 |
| DOUGH PRECURSOR: | | |
| Whole Wheat Bread Flour | 36.36 | 11.01 |
| Instant Yeast | 0.73 | 0.22 |
| Isolated Soy Protein | 22.73 | 6.88 |
| Soybean Oil | 4.82 | 1.46 |
| Dough Conditioner | 0.60 | 0.18 |
| Monoglycerides | 0.89 | 0.27 |
| Sugar | 14.55 | 4.40 |
| Sodium Stearoyl | 0.60 | 0.18 |
| Salt | 2.91 | 0.88 |
| Amylase | 0.03 | 0.01 |
| Bread Flavor | 0.60 | 0.18 |
| Calcium Propionate | 0.60 | 0.18 |
| Emulsifier | 0.30 | 0.09 |
| Water | 72.73 | 22.02 |
| Total | 330.27 | 100.00 |

The whole wheat bread flour is available from Bakemark, St. Louis, Mo., as item #1243800.

### Example 3

A low-carbohydrate bun dough, with 12 g of net carbohydrates per 57 g serving or 21% by weight of net carbohydrates, is produced from the dough formulation shown in Table III. The sponge ingredients are mixed in a water-cooled jacketed mixing bowl maintained at 70° F. for about 30 seconds on #1 speed, approximately 61 rpm, and then for about 4 minutes on #2 speed, approximately 113 rpm, using a Hobart A200 mixer. The mixed sponge is placed in a greased plastic container, covered with plastic wrap, and allowed to ferment for about 2 hours, at a temperature of about 80° F. The dough precursor ingredients are mixed for about 15 seconds on #1 speed, approximately 61 rpm. The fermented sponge is then added to the dough precursor and the combination is then mixed for about 15 seconds on #1 speed, approximately 61 rpm, and then for about 6 minutes on #2 speed, approximately 113 rpm to form the final dough mixture. The dough is then divided into 64 gram dough pieces. Dough pieces are rounded by hand into balls. The rounded dough pieces are then rested on a laboratory bench top for 10 minutes. Dough pieces are then placed in a hamburger bun baking pan, each pan holding four dough pieces, and each piece is flattened slightly by hand. The slightly flattened dough pieces are proofed until the dough rises to approximately double its original size, but for no more than 70 minutes. The dough pieces are then baked at 400° F. for 10 minutes in an electric powered reel oven.

TABLE III

| | Flour % (proportion | |
|---|---|---|
| | of ingredient | Total % (proportion |
| | relative to weight | of ingredient |
| | of total flour, with | relative to weight |
| | proportion of total | of total dough |
| Ingredient | flour set at 100%) | ingredients) |
| SPONGE: | | |
| Bread Flour | 50.00 | 11.87 |
| Vital Wheat Gluten | 56.52 | 13.42 |
| Instant Yeast | 2.61 | 0.62 |
| Yeast Food | 0.87 | 0.21 |
| Protease | 0.02 | 0.005 |
| Soybean Oil | 4.35 | 1.03 |
| Water | 65.22 | 15.48 |
| DOUGH PRECURSOR: | | |
| Bread Flour | 50.00 | 11.87 |
| Instant Yeast | 3.26 | 0.77 |
| Isolated Soy Protein | 23.91 | 5.68 |
| Soybean Oil | 1.74 | 0.41 |
| Sodium Stearoyl Lactylate | 0.87 | 0.21 |
| DATEM | 0.87 | 0.21 |
| Salt | 2.83 | 0.67 |
| Resistant Cornstarch | 21.74 | 5.16 |
| Polydextrose | 17.39 | 4.13 |
| High Fructose Corn Syrup | 17.39 | 4.13 |
| Transglutaminase | 0.04 | 0.01 |
| Sodium Bicarbonate | 0.74 | 0.18 |
| Sodium Aluminum Phosphate | 0.78 | 0.19 |
| Azodicarbonamide | 0.004 | 0.001 |
| Artificial Sweetener | 0.004 | 0.001 |
| Calcium Propionate | 0.10 | 0.02 |
| Water | 100.00 | 23.74 |
| Total | 421.26 | 100.00 |

The bread flour, vital wheat gluten, instant yeast, yeast food, protease, soybean oil, isolated soy protein, sodium stearoyl lactylate, DATEM, and calcium propionate are all acquired from the suppliers disclosed in Example 1. The resistant cornstarch is available from National Starch & Chemical Company, under the trademark Novelose®260. The polydextrose is available from Danisco Cultor USA, New Century, Kans., under the trademark Litesse®. The high fructose corn syrup is available from International Food Products, St. Louis, Mo., under the trade designation 42 High Fructose Corn Syrup. The transglutaminase is available from AB Enzymes, Fort Mill, S.C., under the trade designation Veron TG. The sodium bicarbonate is available from Balchem Encapsulates, New Hampton, New York, as encapsulated sodium bicarbonate, under the trade designation Bakeshure 184. The sodium aluminum phosphate is available from Balchem Encapsulates, New Hampton, N.Y., as encapsulated sodium aluminum phosphate, under the trade designation Bakeshure 645. The azodicarbonamide is available from Burns Philip Food Inc., Fenton, Mo., under the trade designation Benchmate Brand ADA-PAR Tablets. The artificial sweetener is available from McNeil Nutritionals Division of McNeil-PPC, Inc., Fort Washington, Pa., as micronized sucralose, under the trademark Splenda® brand.

### Example 4

A low-carbohydrate bun dough, with 8 g of net carbohydrates per 57 g serving or 14% by weight of net carbohydrates, is produced from the dough formulation shown in Table IV. This bun dough is made with largely the same ingredients as the dough of Example 3, as well as some additional ingredients (different and additional ingredients are noted below), and according to the procedure disclosed in Example 3.

TABLE IV

| | Flour % (proportion | |
|---|---|---|
| | of ingredient | Total % |
| | relative to weight | (proportion of |
| | of total flour, with | ingredient relative |
| | proportion of total | to weight of total |
| Ingredient | flour set at 100%) | dough ingredients) |
| SPONGE: | | |
| Bread Flour | 50.00 | 8.97 |
| Vital Wheat Gluten | 80.56 | 14.46 |
| Instant Yeast | 3.61 | 0.65 |
| Yeast Food | 1.11 | 0.20 |
| Protease | 0.06 | 0.01 |
| Soybean Oil | 5.56 | 1.00 |
| Water | 91.67 | 16.45 |
| DOUGH PRECURSOR: | | |
| Bread Flour | 50.00 | 8.97 |
| Vital Wheat Gluten | 11.11 | 1.99 |
| Instant Yeast | 4.72 | 0.85 |
| Isolated Soy Protein | 16.67 | 2.99 |
| Soy Protein Concentrate | 22.22 | 3.99 |
| Soybean Oil | 2.22 | 0.40 |
| Sodium Stearoyl Lactylate | 1.11 | 0.20 |
| DATEM | 1.11 | 0.20 |
| Salt | 2.83 | 0.51 |
| Resistant Cornstarch | 38.89 | 6.98 |
| Polydextrose | 25.00 | 4.49 |
| High Fructose Corn Syrup | 22.22 | 3.99 |
| Transglutaminase | 0.01 | 0.002 |
| Sodium Bicarbonate | 1.00 | 0.18 |
| Sodium Aluminum Phosphate | 1.11 | 0.20 |
| Azodicarbonamide | 0.002 | 0.0003 |
| Artificial Sweetener | 0.01 | 0.002 |
| Calcium Propionate | 0.13 | 0.02 |
| Bread Flavor | 1.67 | 0.30 |
| Xylanase | 0.33 | 0.06 |
| Water | 122.22 | 21.94 |
| Total | 557.15 | 100.00 |

The soy protein concentrate is available from The Solae Company, St. Louis, Mo., under the trademark Procon®2000. The xylanase is available from Danisco Cultor USA, New Century, Kans., under the trade designation Grindamyl H849. The bread flavor is available from International Flavors & Fragrances, Dayton, N.J., under the trade designation SN424631.

### Example 5

A low-carbohydrate pizza dough, with 6 g of net carbohydrates per 43 g serving or 14% by weight of net carbohydrates, is produced from the dough formulation shown in Table V. All of the ingredients, except water, are mixed in a mixing bowl for about 1 minute on #1 speed, approximately 61 rpm, and then water is added to the other ingredients and mixing continues at the same speed for an additional 6 minutes. The ingredients are mixed using a Hobart A200 mixer. The resulting dough is then divided into 340 gram pieces which are coated with soybean oil. The oiled dough pieces are then placed in plastic bags and refrigerated at a temperature of 32-40° F. overnight, for approximately 16 hours. The dough pieces are then removed from the refrigerator and allowed to sit at room temperature for approximately 45 minutes. Dough pieces are then rolled out into circular shapes with diameters of approximately 14 inches using a standard wooden rolling pin. Rolled out dough is placed on paper pizza baking trays. Each dough tray is placed in a plastic bag and the dough is allowed to proof at room temperature for approximately 90 minutes. The dough is then topped with tomato sauce and cheese and baked for 12-14 minutes at 425° F. in a standard household type oven.

TABLE V

| | Flour + Gluten % | |
|---|---|---|
| | (proportion of ingredient | Total % |
| | relative to total weight of | (proportion of |
| | flour and gluten, with | ingredient relative |
| | proportion of these total | to weight of total |
| Ingredient | ingredients set at 100%) | dough ingredients) |
| Bread Flour | 56.07 | 19.77 |
| Vital Wheat Gluten | 43.93 | 15.49 |
| Instant Yeast | 1.87 | 0.66 |
| Protease | 0.06 | 0.02 |
| Isolated Soy Protein | 32.71 | 11.53 |
| Soybean Oil | 2.99 | 1.05 |
| Dried Egg White | 18.69 | 6.59 |
| Soy Lecithin | 1.12 | 0.40 |
| Resistant Wheat Starch | 8.41 | 2.97 |
| Resistant Cornstarch | 7.21 | 2.54 |
| Toasted Oat Flavor | 1.53 | 0.54 |
| Parmesan Cheese Flavor | 0.24 | 0.08 |
| Salt | 2.24 | 0.79 |
| Water | 106.54 | 37.56 |
| Total | 283.61 | 100.00 |

The bread flour, vital wheat gluten, instant yeast ingredient, protease, isolated soy protein, and soybean oil are all acquired from the suppliers disclosed in Example 1. The dried egg white is available from Bakemark, St. Louis, Mo., item #9056900. The soy lecithin is available from The Solae Company, St. Louis, Mo., under the trademark Centrolex® F. The resistant wheat starch is available from Midwest Grain Products, Atchison, Kans., under the trademark Fiberstar™ 70. The resistant cornstarch is available from National Starch & Chemical Company, under the trademark Novelose® 260. The toasted oat flavor is available from Mane, Cincinnati, Ohio, as Toasted Oat Flavor, item #F96371. The Parmesan cheese flavor is available from Dairiconcepts, Springfield, Mo., as Dehydrated Pasteurized Process Parmesan Cheese, item #35518.

### Example 6

A low-carbohydrate pizza dough, with 9 g of net carbohydrates per 43 g serving or 21% by weight of net carbohydrates, is produced from the dough formulation shown in Table VI. This pizza dough is made with largely the same ingredients as the pizza dough of Example 5 and according to the procedure disclosed in Example 5.

TABLE VI

| | Flour + Gluten % | |
|---|---|---|
| | (proportion of ingredient | |
| | relative to total weight of | Total % (proportion of |
| | flour and gluten, with | ingredient relative |
| | proportion of these total | to weight of |
| Ingredient | ingredients set at 100%) | total dough ingredients) |
| Bread Flour | 63.91 | 28.33 |
| Vital Wheat Gluten | 36.09 | 16.00 |
| Instant Yeast | 1.55 | 0.69 |
| Protease | 0.05 | 0.02 |
| Isolated Soy Protein | 16.80 | 7.45 |
| Soybean Oil | 2.47 | 1.10 |
| Dried Egg White | 8.29 | 3.68 |
| Soy Lecithin | 0.54 | 0.24 |
| Resistant Cornstarch | 8.29 | 3.68 |
| Toasted Oat Flavor | 1.25 | 0.55 |
| Salt | 1.85 | 0.82 |
| Water | 84.49 | 37.46 |
| Total | 225.58 | 100.00 |

### Example 7

A low-carbohydrate pizza dough, with 4 g of net carbohydrates per 43 g serving or 9% by weight of net carbohydrates, is produced from the dough formulation shown in Table VII. This pizza dough is made with the ingredients disclosed in Example 5 and according to the procedure disclosed in Example 5. In accordance with certain embodiments of the present invention, a pizza dough with at least 6.25 g of soy protein may be produced, thereby qualifying for the FDA health claim of reducing the risk of heart disease, as discussed above. To qualify for the health claim, foods must contain at least 6.25 grams of soy protein per serving and fit other criteria, such as being low in fat, cholesterol, and sodium.

TABLE VII

| | Flour + Gluten + Wheat | |
|---|---|---|
| | Starch % (proportion of | Total % |
| | ingredient relative to total | (proportion |
| | weight of flour, gluten, and | of ingredient |
| | wheat starch, with | relative to weight |
| | proportion of these total | of total dough |
| Ingredient | ingredients set at 100%) | ingredients) |
| Bread Flour | 28.04 | 9.44 |
| Vital Wheat Gluten | 37.38 | 12.59 |
| Instant Yeast | 1.87 | 0.63 |
| Protease | 0.06 | 0.02 |
| Isolated Soy Protein | 37.38 | 12.59 |
| Soybean Oil | 2.99 | 1.01 |
| Dried Egg White | 23.36 | 7.87 |
| Soy Lecithin | 1.12 | 0.38 |
| Resistant Wheat Starch | 34.58 | 11.64 |
| Resistant Cornstarch | 14.02 | 4.72 |
| Toasted Oat Flavor | 1.53 | 0.52 |
| Parmesan Cheese Flavor | 0.24 | 0.08 |
| Salt | 2.24 | 0.75 |
| Water | 112.15 | 37.77 |
| Total | 296.96 | 100.00 |

### Example 8

A low-carbohydrate pizza dough, with 7 g of net carbohydrates per 35 g serving or 20% by weight of net carbohydrates, is produced from the dough formulation shown in Table VIII. This pizza dough is made with many of the same ingredients as the pizza dough of Example 5, as well as some additional ingredients (different and additional ingredients are noted below), and according to the procedure disclosed in Example 5, except that the dough is divided into dough pieces that each weighed 384 grams.

TABLE VIII

| | Flour % (proportion of | Total % |
|---|---|---|
| | ingredient relative to | (proportion of |
| | weight of total flour, | ingredient relative |
| | with proportion of total | to weight of total |
| Ingredient | flour set at 100%) | dough ingredients) |
| Bread Flour | 100.00 | 20.30 |
| Vital Wheat Gluten | 73.44 | 14.91 |
| Instant Yeast | 1.56 | 0.32 |
| Protease | 0.10 | 0.02 |
| Isolated Soy Protein | 18.75 | 3.81 |
| Soy Protein Concentrate | 31.25 | 6.34 |
| Soybean Oil | 6.25 | 1.27 |
| Dried Egg White | 31.25 | 6.34 |
| Soy Lecithin | 4.06 | 0.82 |
| Resistant Wheat Starch | 15.63 | 3.17 |
| Sodium Bicarbonate | 0.14 | 0.03 |
| Sodium Aluminum | 0.16 | 0.03 |
| Phosphate | | |
| Pizza Flavor | 1.00 | 0.20 |
| Polydextrose | 4.69 | 0.95 |
| Xanthan Gum | 2.81 | 0.57 |
| Emulsifier | 1.25 | 0.25 |
| Salt | 3.75 | 0.76 |
| Water | 196.56 | 39.90 |
| Total | 492.65 | 100.00 |

The soy protein concentrate is available from The Solae Company, St. Louis, Mo., under the trademark Procon® 2000. The sodium bicarbonate is available from Balchem Encapsulates, New Hampton, N.Y., as encapsulated sodium bicarbonate, under the trade designation Bakeshure 184. The sodium aluminum phosphate is available from Balchem Encapsulates, New Hampton, N.Y., as encapsulated sodium aluminum phosphate, under the trade designation Bakeshure 645. The pizza flavor is available from International Flavors & Fragrances, Dayton, N.J., under the trade designation SN428618. The polydextrose is available from Danisco Cultor USA, New Century, Kans., under the trademark Litesse®. The xanthan gum is available from TIC Gums, Belcamp, Md., under the trademark TIC PRETESTED® TICAXAN® Xanthan 200. The emulsifier is available from Aromatic, Stockholm, Sweden, under the trade designation Aromatic 305:3.

### Example 9

Any one of the above-disclosed pizza doughs may also be frozen for later use. The procedure disclosed in Example 5 or Example 8, for the 7 g net carbohydrate pizza dough, is followed with regard to mixing and dividing the dough. However, the dough pieces are not oiled or refrigerated; after the dough is divided into pieces, the dough pieces are promptly set aside and allowed to rest at room temperature for approximately 1 hour. Dough pieces are then rolled out into circular shapes, according to the procedure disclosed in Example 5. Rolled out dough is then placed on paper pizza baking trays, covered tightly with plastic wrap, and frozen. When such frozen dough is subsequently baked, the dough is initially thawed at room temperature for 1 hour. The dough is then topped with tomato sauce and cheese and baked according to the procedure disclosed in Example 5.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above methods without departing from the scope of the invention, it is intended that all matter contained in the above description shall be interpreted as illustrative and not in a limiting sense.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

1. A dough composition comprising additive gluten, a protease, and a source of soy protein wherein the weight ratio of said soy protein to additive gluten is at least about 0.2:1 and the net carbohydrate content is not greater than about 40% by weight.

2. The dough composition of claim 1 wherein said source of soy protein is selected from the group consisting of soy protein isolate, soy protein concentrate, textured soy protein, and combinations thereof.

3. The dough composition of claim 1 comprising an indigestible carbohydrate component.

4. The dough composition of claim 1 wherein said additive gluten is wheat gluten.

5. The dough composition of claim 1 wherein the additive gluten and the protease are contained within a sponge composition.

6. The dough composition of claim 1 wherein the soy protein source is contained within a dough precursor composition.

7. The dough composition of claim 1 wherein the dough composition has an activity product ((units/gram of activity)(% weight of protease)) between about 20 and about 800.

8. The dough composition of claim 1 wherein the dough composition has an additive gluten content of between about 2% by weight and about 25% by weight.

9. The dough composition of claim 1 wherein the dough composition has a soy protein content of between about 3% by weight and about 20% by weight.

10. The dough composition of claim 1 wherein said dough composition is defined by an amino acid score comprising:

| | Amino Acid Score |
|---|---|
| | (ratio (mg/g protein)/ideal ratio |
| Amino Acid | (mg/g protein)) |
| Lysine | 42%-95% |
| Methionine + Cystine | 79%-161% |

11. The dough composition of claim 1 wherein the dough composition has a water content of between about 35% water by weight and about 55% water by weight.

12. A dough composition comprising additive gluten, a protease, and a source of soy protein wherein the activity product ((units/gram of activity)(% weight of protease)) of said dough composition is between 20 and 800.

13. A bread product prepared by a process comprising baking the dough composition of claim 1.

14. A baked bread product comprising soy protein and additive gluten wherein the weight ratio of soy protein to additive gluten is at least about 0.2:1, the net carbohydrate content is not greater than about 40% by weight, the moisture content is at least about 20% water by weight, and the texture and shelf life are comparable to the texture and shelf life of a conventional bread product.

15. The baked bread product of claim 14 wherein said bread product is defined by an amino acid score comprising:

| | Amino Acid Score (ratio (mg/g protein)/ideal |
|---|---|
| Amino Acid | ratio (mg/g protein)) |
| Lysine | 42%-95% |
| Methionine + Cystine | 79%-161% |

16. The baked bread product of claim 14 wherein the bread product is selected from the group consisting of pizza, buns, or loaf breads.

17. A process for preparing the dough composition of claim 1 comprising the steps of:
preparing a sponge composition comprising said additive gluten and the protease;
fermenting said sponge composition;
preparing a dough precursor composition comprising the soy protein source;
combining the fermented sponge composition with the dough precursor composition; and
allowing the combined composition to ferment.

18. The process of claim 17 wherein the source of soy protein is selected from the group consisting of soy protein isolate, soy protein concentrate, textured soy protein, and combinations thereof.
